(19) United States
(12) Patent Application Publication
(10) Pub. No.: US 2026/0307922 A1
(43) Pub. Date: Oct. 8, 2026

(54) SEPARATION DEVICE FOR SEPARATED DISPENSING OF A SLICED FOOD PRODUCT

(71) Applicant: REET Systems GmbH, Wien (AT)

(72) Inventor: Dieter SPRANZ, Oberwaltersdorf (AT)

(73) Assignee: REET Systems GmbH, Wien (AT)

(21) Appl. No.: 19/482,191

(22) PCT Filed: May 8, 2024
(86) PCT No.: PCT/AT2024/060200

§ 371 Date: Nov. 6, 2025

(30) Foreign Application Priority Data
May 9, 2023 (AT) A50357/2023

(51) Int. Cl. B65G 59/02; B65G 43/00

(52) U.S. Cl. CPC B65G 59/023; B65G 43/00; B65G 2201/0202; B65G 2201/022; B65G 2203/0233; B65G 2203/0266; B65G 2814/031

(57) ABSTRACT

A separation device (100) and system for separated dispensing of sliced food product (10) is provided. Such devices can include a carrier unit (1) having multiple tiers (11) and a receiving container (2) for receiving and guiding the carrier unit (1). The carrier unit (1), in a starting position, being received, in particular fully, receiving container (2), transport device (5), which can be coupled to carrier unit (1) and/or receiving container (2), and ejection device (6), which can be reversibly moved, linearly relative to carrier unit (1) and in parallel with the plane of product carrier (12), from a basic position, in which ejection device (6) is outside carrier unit (1), into an ejection position, the transport device (5) being designed to transport a tier (11) of carrier unit (1) out of receiving container (2) when ejection device (6) adopts the basic position, in particular following an ejection process.

The invention relates to a separation device for separated dispensing of a sliced food product according to claim 1, to a method according to claim 15, and to a system for preparing assembled food products according to claim 16.

Countless types of pizza, sandwiches, tacos and the like are prepared every day, especially in fast-food restaurants. Customers place particular emphasis on consistent product quality and the quick and hygienic production of ordered dishes. In this context, it is desirable that as many production steps as possible are automated and carried out without human intervention, so that errors such as forgetting certain ingredients or toppings can be reliably avoided when preparing the ordered dishes. However, vegetable garnishes such as tomato slices in particular have so far been difficult to apply to dishes automatically, as they are sensitive to handling and, if handled improperly, can easily lose juice or seeds, thus making the dish look unappetizing and leading to contamination of the production facility.

From EP 3504976 A1 a device for dispensing various garnishes onto sandwiches or the like is known. The various garnishes, such as cucumbers, tomatoes, onions, or the like, are placed—each whole, i.e. in one piece—into containers arranged above a conveyor belt on which the sandwich to be filled is transported. A blade is located beneath each container that cuts the garnishes into slices, which then fall onto the sandwiches being transported past it. The containers with the garnishes are arranged vertically so that the garnishes have to slide towards the blade due to the effect of gravity.

A disadvantage of this known device, however, is that the pieces of vegetables can easily become wedged in the containers because the effect of gravity does not ensure reliable sliding, delicate vegetables such as tomatoes can be squeezed when stacked in the containers or when cut by the blade, and any resulting vegetable juice drips onto the conveyor belt below and the dishes being transported past. Furthermore, if the blade breaks or splinters, sharp pieces of metal can get onto the assembled product or dish and seriously injure employees, which represents a significant safety risk.

The object of the invention is therefore to remedy this situation and to provide a device for the separated dispensing of a food product, which is suitable for the automated dispensing of sensitive food products such as tomatoes, ensures cleanliness and hygienic and safe production as well as consistent quality of the dishes produced.

The invention achieves this object with a separation device for the separated dispensing of a sliced food product with the characterizing features of claim 1.

According to the invention, the separation device comprises the following components:
a carrier unit with a plurality of tiers for receiving the individual food products, wherein the tiers are aligned parallel to each other and each comprise a product carrier on which the individual food products can be placed,
a receiving container for receiving and guiding the carrier unit, wherein the carrier unit is received in a starting position, in particular completely, in the receiving container,
a transport device which can be coupled to the carrier unit and/or the receiving container and is designed to transport the carrier unit linearly step by step from its starting position out of the receiving container, so that one respective tier of the carrier unit can be transported step by step out of the receiving container, and
an ejection device which can be reversibly moved, linearly relative to the carrier unit and parallel to the plane of the product carriers from a basic position in which the ejection device is located outside the carrier unit, to an ejection position in which the ejection device is at least partially inserted between the product carriers of the carrier unit outside and/or inside the receiving container, so that food products placed on the product carriers in this way can be conveyed individually out of the carrier unit by the ejection device,
wherein the transport device is designed to transport a tier of the carrier unit out of the receiving container when the ejection device assumes the basic position, in particular following an ejection process.

This design of a separation device according to the invention advantageously ensures that sliced food products stored in the carrier unit can be dispensed individually in an automated manner in order to top a pizza or a sandwich, for example. This automated separation is ensured by the fact that the tiers of the carrier unit, each containing individual food products, are transported step by step individually out of the receiving container. Once a new tier with a food product placed on it has been transported from the receiving container, the ejection device is moved from the basic position to the ejection position. In this position, the ejection device is at least partially inserted into the tier of the carrier unit in which the food product is located, so that the ejection device pushes the food product placed on the product carrier off the product carrier and this is thus conveyed out of the carrier unit. This design of a device according to the invention advantageously also ensures the separated dispensing of sensitive food products, such as tomato slices or other fruit and vegetable slices.

The ejection device can assume its ejection position outside the receiving container, which is advantageous if a food product is to be transported from a tier of the carrier unit transported by the transport unit from the receiving container—i.e. a tier that is located outside the receiving container. However, the ejection device can optionally also reach its ejection position within the receiving container if, for example, the receiving container is designed accordingly, for example if the receiving container has corresponding recesses, flaps or the like on, for example, side or outer surfaces, through which, on the one hand, the ejection device can be moved into the receiving container between the product carriers of the carrier unit and, on the other hand, the food products can be conveyed individually out of the carrier unit and out of the receiving container by the ejection device. Optionally, both variants of the ejection position can also be provided in a separation device according to the invention and can be selected depending on the food product to be separated.

Because the carrier unit is received in a receiving container and is guided in this, while the carrier unit is transported out of the receiving container by the transport unit, any juice from vegetable or fruit food products dripping from the carrier unit is reliably collected, thus ensuring cleanliness and hygiene during the preparation of the dishes that are topped with the individually dispensed sliced food products.

In the context of the invention, a slice or sliced body is not only to be understood as a geometric body in the form of a cylinder the radius of which is many times greater than its thickness, but more generally as a body with any cross-sectional surface the height of which is many times smaller than its extension in the plane.

A particularly precise coordination of the movements of the transport device and the ejection device with one another while maintaining a compact design of the device can be achieved if the separation device comprises a control unit connected to the transport device and the ejection device, which is designed
to control the transport device to transport one respective tier of the carrier unit out of the receiving container when the separating unit assumes the basic position and
to control the ejection device for movement from the basic position to the ejection position and from the ejection position to the basic position,
wherein the control unit is designed
after transporting a new tier of the carrier unit from the receiving container, to control the ejection device for movement to the ejection position, and then
to control the ejection device to move to the basic position.

In order to ensure an essentially continuous operation of the separation device without prolonged downtimes, it can be provided that the control unit is designed to monitor the transport movement of the transport device and to emit a warning signal after the transport of a predetermined, in particular the last, tier of the carrier unit from the receiving container, wherein it is provided in particular that the number of tiers of the carrier unit is stored in the control unit.

This ensures that the operating personnel are warned when a certain tier of the carrier unit has been removed from the receiving container, so that they already can, for example, prepare a new, filled carrier unit to quickly replace the empty carrier unit, thus minimizing or completely eliminating the downtime of the device.

For a particularly simple replacement of an emptied carrier unit, it can be provided that the control unit is designed to control the transport device after the last tier of the carrier unit has been transported out of the receiving container, to transport the carrier unit back to the starting position in the receiving container and to uncouple the carrier unit, wherein it is provided in particular that the number of tiers of the carrier unit is stored in the control unit.

Because in this embodiment of a separation device according to the invention the emptied carrier unit is transported back to its starting position in the receiving container and is uncoupled, the carrier unit together with the receiving container with any collected juice or the like can be easily and quickly removed from the device and replaced by a new carrier unit with receiving container.

In order to be able to additionally utilize the effect of gravity when dispensing the food products in a separation device according to the invention, it can be provided that the receiving container is arranged on an inclined plane which is oriented at an angle, in particular of 5 to 45 degrees, relative to the horizontal, and that the plane of the individual product carriers of the carrier unit, in their guided state within the receiving container, is oriented substantially at the same angle to the horizontal.

Due to this design of the separation device, the food products placed on the product carriers slide out of the carrier unit more easily due to the effect of gravity when they are ejected by the ejection device. This enables even more gentle transport of particularly sensitive food products. The effect of gravity additionally simplifies the refilling of a separation device according to the invention with filled carrier units or receiving containers when multiple receiving containers with carrier units are supported on the inclined plane. If an empty carrier unit is removed along with the receiving container, another filled carrier unit simply slides along into another receiving container.

In order to be able to use the effect of gravity in the dispensing of the individual food products in an even more targeted manner, it can be provided that the ejection device is linearly movable in a plane which is oriented at substantially the same angle to the horizontal as the inclined plane.

In this way, gravity and the force transmitted by the ejection device act in the same direction, which makes conveying food products even more gentle.

In order to further accelerate the replacement of emptied carrier units and thus further reduce the downtime of the device, it can be provided that (i) the device comprises at least one further carrier unit and one further receiving container for receiving and guiding the further carrier unit, wherein the further receiving container is arranged on the inclined plane and in particular (ii) the device comprises a removal device which is designed to remove the carrier unit and the receiving container from the inclined plane, in particular to drop them, after the carrier unit has been transported back to the starting position.

This design ensures, on the one hand, that emptied carrier units with the receiving container including collected vegetable juice or the like are transported out of the device by the removal device. On the other hand, the storage of one or more additional receiving containers including the carrier unit on the inclined plane ensures that another receiving container including the carrier unit slides along downwards as soon as the emptied carrier unit including the receiving container has been removed. This further reduces the downtime of the device, so that there is virtually no interruption in the dispensing of food products during regular operation of the device.

In this context, it can be particularly advantageous if the control unit is designed to control the removal device for removal, in particular for discharge, of the carrier unit and the receiving container, so that the device can be designed to be compact and with a small number of individual components.

A particularly rapid continued operation of the separation device after the removal of an emptied carrier unit can be ensured if the control unit is designed to control the transport device to couple the further carrier unit after the removal of the carrier unit and the receiving container from the inclined plane.

In this way, the transport device quickly couples itself to the additional, filled carrier unit without human intervention, so that the dispensing of individual food products from the additional carrier unit can begin particularly quickly.

A particularly gentle further transport of individually dispensed food products to, for example, further processing stations in the preparation of dishes can be ensured if the separation device comprises a platform guided to the upper edge of the receiving container, wherein food products placed on the product carriers can be conveyed individually from the carrier unit onto the platform by the ejection device and wherein it is provided in particular that the platform
is oriented at the same angle to the horizontal as the inclined plane or
is oriented horizontally.

The carrier unit can be designed to be particularly compact if the carrier unit, in particular each of the product carriers of the carrier unit, has a substantially round cross-section and if the receiving container is designed as a hollow cylinder open on one side.

A particularly quick coupling and decoupling between the transport unit and the carrier unit can be ensured if the carrier unit has a fastening device, in particular a hook or bracket, on its side facing away from the bottom of the receiving container for coupling to the transport device.

A particularly quick coupling and decoupling between the transport unit and the receiving container can be ensured if the bottom of the receiving container has a fastening device, in particular a hook or bracket, for coupling to the transport device, and if the transport device is designed to transport the carrier unit linearly step by step from its starting position out of the receiving container by moving the bottom of the receiving container.

Particularly reliable protection of the food products against falling out of the carrier unit and, at the same time, effective protection of the food products against drying out can be ensured if each tier of the carrier unit is delimited by two respective product carriers, wherein it is particularly provided that the distance between each two product carriers essentially corresponds to the height of the food product to be placed on it.

According to a particularly advantageous variant of a separation device according to the invention with particularly low operating effort, it can be provided that the separation device comprises at least one further carrier unit and at least one further receiving container for receiving and guiding the further carrier unit, and
that the separation device comprises a removal device which is designed
after the carrier unit has been returned to its starting position, to remove the carrier unit and the receiving container from the separation device, in particular to discharge them, and
to transport the further receiving container with the further carrier unit, in particular by means of a piston and/or a chain guide, to the location of the previously removed, in particular discharged, receiving container,
wherein it is preferably provided that the control unit is designed to control the removal device for removal, in particular for ejection, of the carrier unit and the receiving container and/or for further transport of the further receiving container with the further carrier unit.

The object of the invention is also to provide a method for separated dispensing of a sliced food product with a separation device, which is suitable for the automated dispensing of sensitive food products such as tomatoes, ensures cleanliness and hygienic and safe production as well as consistent quality of the dishes produced.

The invention achieves this object with a method for separated dispensing of a sliced food product with a separation device according to the invention, according to claim 15.

In particular, the following steps are provided:
wherein a carrier unit filled with food products is brought into its starting position in the receiving container,
wherein the transport device is coupled to the carrier unit and/or the receiving container,
wherein the carrier unit is transported linearly step by step by the transport device from its starting position out of the receiving container, so that one respective tier of the carrier unit is transported step by step out of the receiving container,
wherein the ejection device is moved, linearly relative to the carrier unit and parallel to the plane of the product carriers from its basic position in which the ejection device is located outside the carrier unit, to its ejection position in which the ejection device is at least partially inserted between the product carriers of the carrier unit outside and/or inside the receiving container, so that the food product placed on the product carrier of the in particular last tier transported out of the receiving container is conveyed individually out of the carrier unit by the ejection device,
wherein the ejection device is moved from the ejection position to the basic position and
wherein a new tier of the carrier unit is transported out of the receiving container by the transport device following the movement of the ejection device to the basic position.

The invention further relates to a system for preparing assembled food comprising a separation device according to the invention. In this context, it can be particularly advantageous if the separation device is designed in a modular manner so that it can be removed from and/or replaced in the system.

Further advantages and embodiments of the invention will be apparent from the description and the attached drawings.

The invention is schematically shown in the drawings based on particularly advantageous but not limiting exemplary embodiments and is described by way of example with reference to the drawings.

In the following schematic figures:

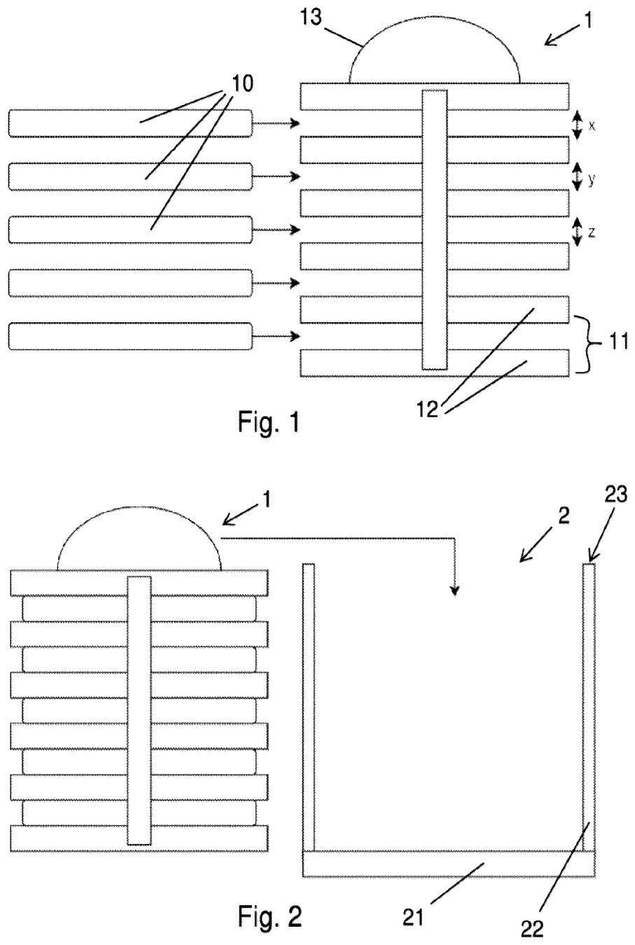

FIG. 1 shows the filling of a carrier unit with food products,

FIG. 2 shows the filled carrier unit from FIG. 1 with a corresponding receiving container,

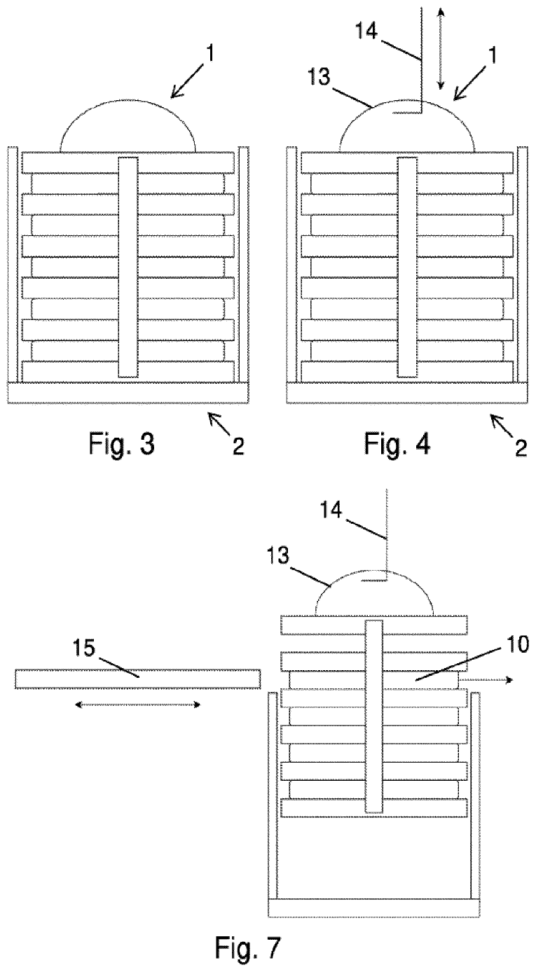

FIG. 3 shows the filled carrier unit from FIG. 1 in its starting position in the receiving container,

FIG. 4 shows the coupling of the carrier unit from FIG. 1 with a transport device,

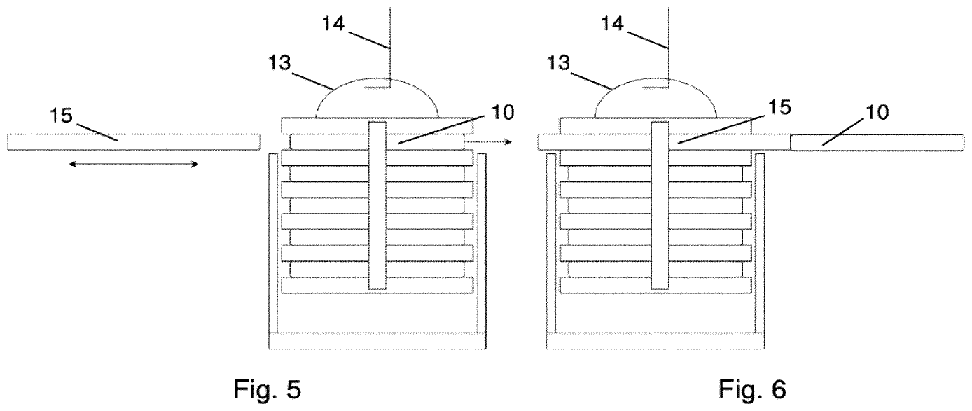

FIG. 5 shows an ejection device in the basic position of the ejection device,

FIG. 6 shows an ejection device from FIG. 5 in the ejection position of the ejection device,

FIG. 7 shows the transport of a new tier of the carrier unit from the receiving container when the ejection device from FIG. 5 assumes the basic position,

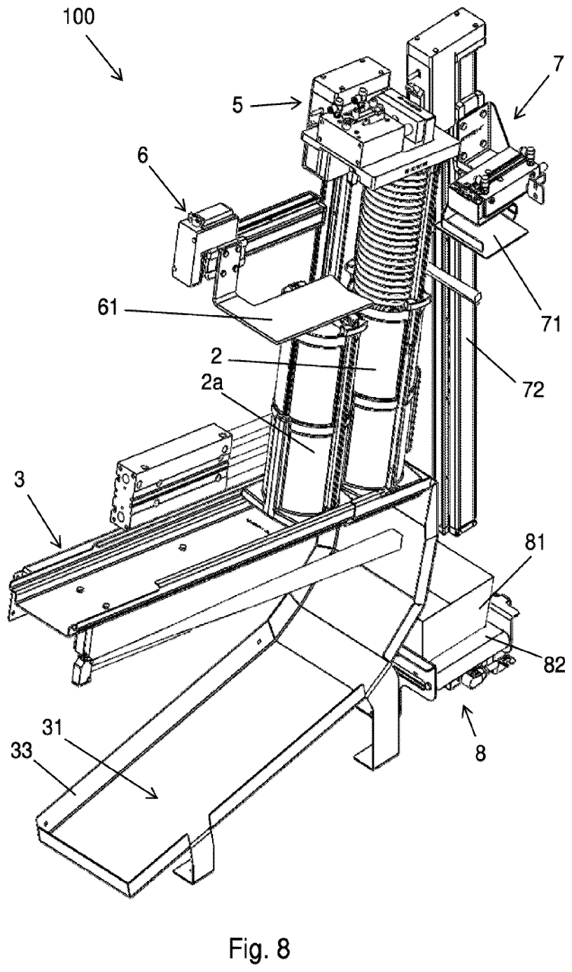

FIG. 8 shows an exemplary embodiment of a separation device according to the invention,

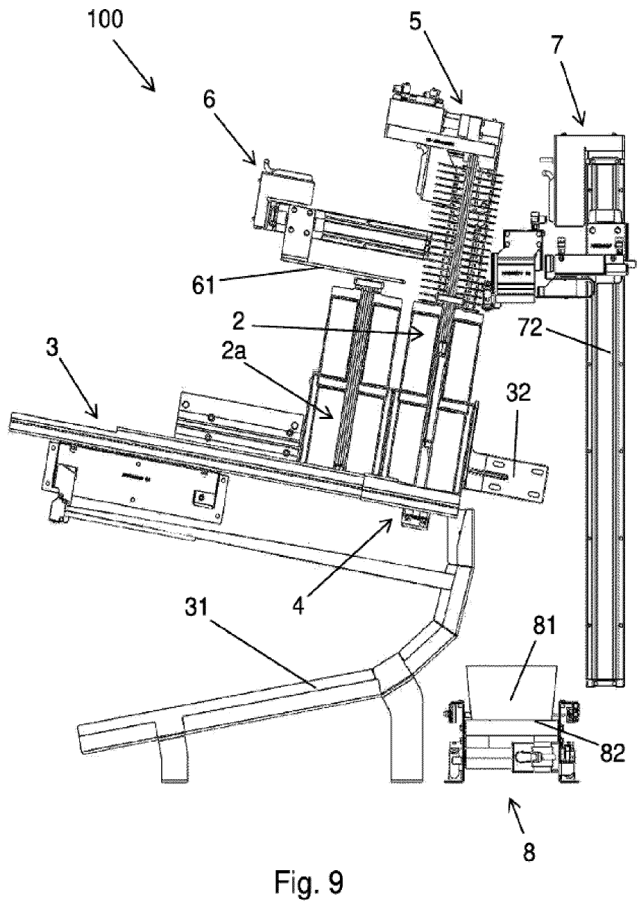

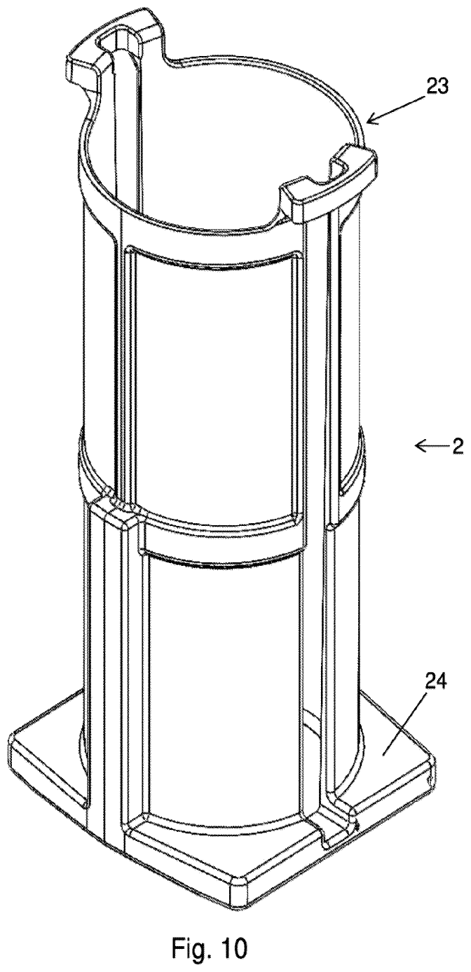

FIG. 9 shows a sectional view of the separation device from FIG. 8,

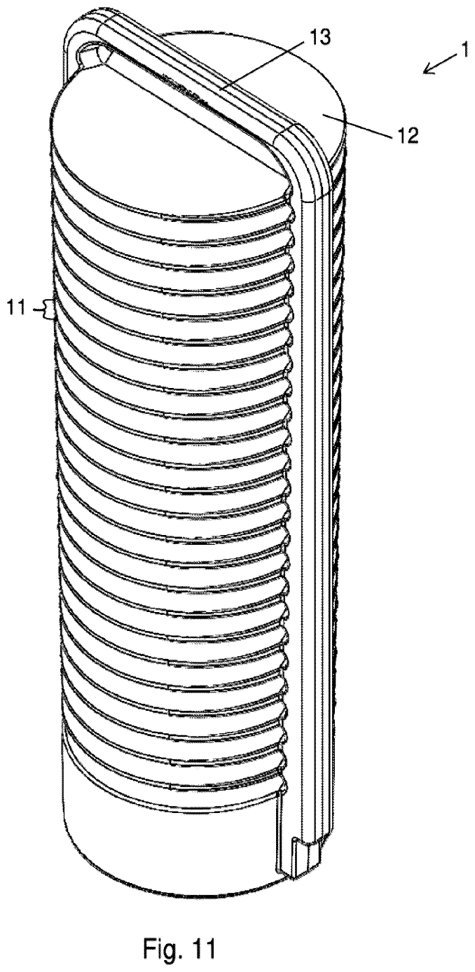

FIG. 10 shows a detailed view of the receiving container of the separation device from FIG. 8,

FIG. 11 shows a detailed view of the carrier unit of the separation device from FIG. 8,

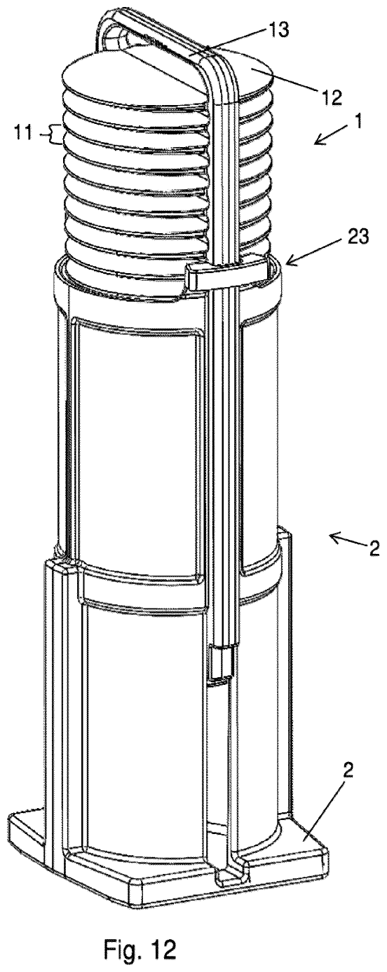

FIG. 12 shows the carrier unit from FIG. 11 guided in the receiving container from FIG. 11.

In the following, the structure and functioning of a separation device 100 according to the invention for separated dispensing of a sliced food product 10 in connection with the dispensing of tomato slices are described by way of example.

However, this exemplary embodiment merely serves to explain the structure and functioning of the separation device 100 according to the invention, and a separation device 100 according to the invention can of course also be used for the separated dispensing of any other sliced food product 10 in connection with the automated production or the automated topping of dishes.

A separation device 100 according to the invention for the separated dispensing of a sliced food product 10 comprises at least one carrier unit 1 with multiple tiers 11 oriented parallel to one another, in which the food products 10 to be dispensed are individually stored or pre-separated. The food products to be separated or individually dispensed, which are manually or automatically cut to a desired height x, y, z, are inserted manually or automatically into this fan-like carrier unit 1. This means that the carrier unit 1 is filled manually or automatically with the food products 10 to be separated.

In the exemplary embodiment of a carrier unit 1 shown in FIG. 1, the individual tiers 11 are each delimited by two product carriers 12 on which the individual food products 10—in the exemplary embodiment tomato slices—can be placed.

In the exemplary embodiment, the distance between each two product carriers 12, i.e. the height of a tier 11, is selected such that it essentially corresponds to the height of the tomato slices placed on top. In such a carrier unit 1, the cut surfaces of the tomato slices are covered by the product carriers 12 so that hardly any air reaches the cut surfaces. This protects the tomato slices from drying out and prevents unappetizing or visually or otherwise qualitatively undesirable discoloration that can occur through contact with air. Adapting the height of the tiers to the height of the food products generally protects water-containing foods from drying out on the cut surfaces. However, the height of the tiers 11 can be varied as required depending on the application, which is indicated in FIG. 1 by the arrows labeled x, y and z.

In the exemplary embodiment, the individual product carriers 12 of the carrier unit 1 have a circular cross-section and the cross-sectional area corresponds approximately to the area of the tomato slices placed on them. This design ensures that the carrier unit 1 is particularly compact on the one hand and that the tomato slices can also be easily conveyed by the product carriers 12.

A separation device 100 according to the invention further comprises at least one receiving container 2, which is shown schematically in FIG. 2 as an example and which receives the carrier unit 1 and serves as a guide in the separation device 100. The receiving container 2 has a bottom 21 and a wall surface 22. In the exemplary embodiment, the receiving container 2 is designed as a hollow cylinder which is open on the side opposite the bottom 21. The wall surface 22 can be designed as a continuous, closed, sealed surface. This is particularly advantageous for catching dripping juice, seeds, or the like from food products 10. Alternatively, the wall surface 22 can of course also optionally have recesses.

As an alternative to the hollow cylindrical shape in the exemplary embodiment, the receiving container 2 of a separation device 100 according to the invention can be designed as a hollow body with any desired cross-sectional shape, wherein the shape of the product carriers 12 is adapted to the cross-sectional shape of the receiving container 2. This enables the best possible adaptation of the carrier unit 1 and the receiving container 2 to the food products 10 to be dispensed.

In the exemplary embodiment, the carrier unit 1 further comprises a fastening device 13 designed as a bracket for coupling to a transport device 5 of the separation device 100. The transport device 5 will be discussed in more detail below. The bracket is arranged on the side of the carrier unit 1 facing away from the bottom 22 of the receiving container 2 (see FIG. 3 and FIG. 4).

As can be seen in FIG. 3, the carrier unit 1 in the exemplary embodiment is completely received in the receiving container 2 in its starting position. Thus, any juice or seeds escaping from the tomato slices are collected in the receiving container 2 and contamination of the separation device 100 is avoided.

As shown in FIG. 4, in the exemplary embodiment a transport device 5 is coupled to the fastening device 13 of the carrier unit 1. In the exemplary embodiment, this is achieved by a hook 14 which engages in the fastening device 13, i.e. the bracket. The transport device 5 transports the carrier unit 1 step by step from its starting position out of the receiving container 2, so that one respective tier 11 is transported step by step out of the receiving container 2. This is a linear movement, which is indicated in FIG. 4 by the vertical arrow, and the carrier unit 1 is guided by the receiving container 2 or the wall surface 22 of the receiving container 2.

The transport device 5 can be implemented in a variety of ways. The only decisive factor is that the transport device 5 enables step-by-step transport of the carrier unit 1.

In the exemplary embodiment, the transport device 5 lifts the carrier unit 1 vertically out of the receiving container 2. However, this transport movement is not to be understood as restrictive and it can also take place at an angle to the vertical, for example when the receiving container 2 is arranged on an inclined plane 3. This will be discussed in more detail below.

As an alternative to coupling with the carrier unit 1, it is also possible to couple the transport device 5, for example, with the bottom 21 of the receiving container 2. In this case, the bottom 21 of the receiving container 2 is movable and has a circumferential seal to the wall surface 22 of the receiving container 2, so that no liquid can leak out even if it is moved. The carrier unit 1 rests on the bottom 21 of the receiving container 2 and is moved along with the bottom 21 when the latter is moved or shifted, and in this way the individual tiers 11 are transported out of the receiving container 2, while the wall surface 22 of the receiving container 2 is not moved and remains stationary.

In the exemplary embodiment, an ejection device 6 with a stamp 15 is used to eject the food product 10 from the carrier unit 1 or to convey the food product 10 from the product carrier 12. In the exemplary embodiment, the ejection device 6 with the stamp 15 moves reversibly from a basic position (see FIG. 5), in which the ejection device 6 or the stamp 15 of the ejection device 6 is located outside the carrier unit 1, into an ejection position (see FIG. 6), in which the ejection device 6 or the stamp 15 of the ejection device 6 is at least partially inserted between the product carriers 12 of the carrier unit 1 and back.

The movement of the ejection device 7 is linear relative to, i.e. in the direction of, the carrier unit 1 and parallel to the plane of the product carriers 12. In order to realize this linear movement parallel to the plane in which the product carriers 12 extend and in the direction of the carrier unit 1 in the exemplary embodiment, the ejection device 6 is guided on a metal frame.

The ejection device 6 can also be implemented in a variety of ways. The only decisive factor is that the ejection device 6, coordinated with the transport of the carrier unit 1 by the transport device 5, can move between the basic position and the ejection position.

FIG. 5 and FIG. 6 schematically show in detail how the stamp 15 is pushed into the new tier 11 of the carrier unit 1 transported from the receiving container 2 by the transport unit 5 and located directly above the upper edge 23 of the receiving container 2, which tier projects beyond the receiving container 2. This means that in the exemplary embodiment, the stamp 15 of the ejection device 6 engages between the individual product carriers 12 of the respective tier 11 of the carrier unit 1 and thus presses the tomato slices placed on the product carriers 12 out of the carrier unit 1. The ejection device 6 then moves back from the ejection position in the carrier unit 1 to the basic position. The movement of the transport device 5 is coordinated with the movement of the ejection device 6 and the carrier unit 1 is moved by the transport device 5 into the next desired position as soon as the ejection device 6 is in the basic position. This means that the next tier 11 of the carrier unit 1 is lifted out of the receiving container 2 (see FIG. 7) as soon as the ejection device 6 is in the basic position and the stamp 15 then separates the next tomato slice.

In the exemplary embodiment in FIGS. 1 to 7, a control unit which is connected to the transport device 5 and the ejection device 6 coordinates the movements of the transport device 5 and the ejection device 6. If the ejection device 6 is in the basic position, the control unit first controls the transport device 5 to transport a tier 11 of the carrier unit 1 from the receiving container 2.

After this transport of a new tier 11 of the carrier unit 1 from the receiving container 2, the control unit controls the ejection device 6 for movement from the basic position to the ejection position. Once the food product 10 has been transported out of the carrier unit 1, the control unit controls the ejection device 6 to move it to the basic position. For this purpose, both the transport device 5 and the ejection device 6 can be provided with a servo motor.

However, such a control unit is optional and an embodiment of a separation device 100 according to the invention is also possible in which, for example, the transport device 5 has a servo motor and the ejection device 6 is preloaded with a spring and is automatically released as soon as a new tier 11 of the carrier unit 1 has been transported from the receiving container 2. In this case, only the transport device 5 is electronically controlled.

Furthermore, the control unit can optionally perform a number of functions to ensure an almost continuous operation of the separation device, in which no major downtimes occur that could arise from filling the carrier unit 1 with food products 10.

For example, the control unit can emit a warning signal in the form of, for example, an acoustic or optical signal when one of the last or the last tier 11 of the carrier unit 1 has been transported out of the receiving container 2, so that the operating personnel are informed by the separation device 100 that the carrier unit 1 will soon be emptied or has already been emptied. This is particularly helpful to ensure a quick replacement of the carrier unit 1 so that food products 10 can be dispensed possibly without any interruption. For this purpose, the number of tiers 11 of the carrier unit 1 is optionally stored in the control unit and the control unit monitors how many of the tiers 11 have already been transported from the receiving container 2.

Optionally, the control unit can also be configured to check whether a food product 10 has actually been conveyed out of the carrier unit 1 after the ejection device 6 has been moved into the ejection position. If no food product 10 was transported from the carrier unit 1, i.e. if a product carrier 12 was not loaded with a food product 10, the control unit can optionally emit a warning signal.

Alternatively or additionally, the control unit can be designed to determine how often a product carrier 12 was not loaded with a food product 11 and to control a removal device 4, which will be discussed in more detail below, to remove the carrier unit 1 together with the receiving container 2 from the separation device 100 if no food product 10 has been placed on it several times in succession, since the carrier unit 1 is then recognized as empty.

Once the last tier 11 of the carrier unit 1 has been transported out of the receiving container 2, the control unit can optionally further control the transport device 5 to lower the carrier unit 1 back into the receiving container 2 and to release the hook 14 from the fastening device 13, so that the carrier unit 1 together with the receiving container 2 can be quickly replaced without the operating personnel of the separation device 100 having to release the connection between the carrier unit 1 and the transport device 5.

In FIGS. 1 to 7 of the exemplary embodiment, the receiving container 2 together with the carrier unit 1 is arranged on a horizontal plane, so that the transport movement of the transport device 5 is vertical and the adjusting movement of the separating unit 6 is horizontal. However, this is optional.

It is particularly advantageous if, instead of a horizontal plane, an inclined plane 3, which forms an angle to the horizontal, is used. In this case, the effect of gravity contributes to a particularly gentle dispensing of the food products 10, since they are not only pushed out of the carrier unit 1 or from the product carrier 12 by the ejection device 6, but also slide due to the effect of gravity. This is particularly beneficial for particularly delicate fruits and vegetables.

In FIG. 8 and FIG. 9, an embodiment of a separation device 100 according to the invention with such an inclined plane 3 is shown schematically.

Since the receiving container 2 stands on the inclined plane 3 and the carrier unit 1 is guided by the receiving container 2 during transport by the transport unit 5, the product carriers 12 also assume at least approximately the same angle to the horizontal as the inclined plane 3 and the transport movement of the transport device 5 and the adjusting movement of the ejection device 6 also take place at approximately the same angle to the horizontal.

As can be seen in FIG. 9, the ejection device 6 in the exemplary embodiment comprises a plate 61 which is guided between the product carriers 12 of the carrier unit 1 and engages in the respective tier 11 of the carrier unit 1 in the ejection position. The plate 61 is moved by a servo motor between the basic position outside the carrier unit 1 and the ejection position, which in the exemplary embodiment is located outside the receiving container 2, and is guided on a frame for this purpose.

The motor of the transport device 5, which transports the carrier unit 1 or its tiers 11 with the product carriers 12 and the tomato slices thereon, out of the receiving container 2, is also arranged on this frame. Due to this arrangement of the transport device 5 and the ejection device 6 on a frame, they are firmly connected and thus the relation or ratio of the adjustment and transport movement to each other is always correct.

Since the separation device 100 has an inclined plane 3 on which the receiving container 2 with the carrier unit 1 is placed, as shown in FIG. 8 and FIG. 9, further receiving containers 2a with further carrier units la can of course also additionally be provided, which are also placed on the inclined plane 3. This ensures a particularly rapid replacement of empty carrier units 1 including the receiving container 2.

In fact, if an emptied carrier unit 1 is transported back to the starting position in the receiving container 2 and removed from the separation device 100 together with the receiving container 2, a further receiving container 2a with a filled further carrier unit la simply slides along and the dispensing of the food products 10 can continue with only a slight interruption for the coupling of the transport device 5 to the further carrier unit la as in FIG. 8 and FIG. 9—or alternatively to the bottom of the further receiving container 2a.

Such an inclined plane 3 can be, as in FIG. 8 and FIG. 9, a flat surface aligned at an angle to the horizontal. However, such an inclined plane 3 can also be realized differently, for example in the form of rails aligned at an angle to the horizontal, on which the carrier unit 1 together with the receiving container 2 and, if applicable, further carrier units la or their fastening device together with further receiving containers 2a are guided.

As can be seen in FIG. 9, the separation device 100 further comprises a bracket 32 which is arranged at that end of the inclined plane 3 which is closer to the bottom or installation surface of the separation device 100. The bracket 32 secures the receiving containers 2, 2a against unwanted slipping from the inclined plane 3.

In the exemplary embodiment, further guidance of the receiving containers 2, 2a on the inclined plane 3 is achieved by a flange 24 which is located at the lower end of the receiving container 2, 2a, which rests on the inclined plane 3. The flange 24 can, as shown in FIG. 8, be guided by guide plates or the like, thus preventing the receiving containers 2, 2a from slipping sideways or tipping down from the inclined plane 3. In addition, it offers a gripping option for the operating personnel when removing the receiving containers 2, 2a from the separation device 100, which will be discussed in more detail below.

The basic structure of a receiving container 2 and a carrier unit 1 has already been described in detail above and also applies to the exemplary embodiment in FIG. 8 and FIG. 9 or the detailed views in FIG. 10, FIG. 11 and FIG. 12. As can be seen in FIG. 11, the fastening device 13, in FIG. 11 again a bracket, also extends laterally along the fan-shaped carrier unit 1. This allows the operating personnel to grip and hold the carrier unit 1 even better, and on the other hand, it provides improved guidance in the receiving container 2, as shown in FIG. 12.

In fact, if the fastening device 13 also extends laterally along the carrier unit 1 and if the receiving container 2 has corresponding grooves or, as in FIG. 10 and FIG. 12, lateral recesses extending along the container wall, the carrier unit 1 is secured against turning or rotating in the receiving container 2. This also improves the coupling with the transport unit 5.

The removal of the emptied carrier unit 1 with the receiving container 2 can be carried out either manually by the operating personnel of the separation device 100 or automatically by means of a removal device 4 such as a gripper, a flap or the like. If a control unit is provided to control the transport and ejection device, the control unit can also control the removal device 4.

In the exemplary embodiment in FIG. 8 and FIG. 9, the separation device 100 comprises a removal device 4 controlled by a control unit in the form of a flap for removing emptied carrier units 1 together with the corresponding receiving containers 2.

If, for example, the control unit detects that the last tier 11 of the carrier unit 1 has been transported out of the receiving container 2, it controls the transport device 5, as described above, to transport the carrier unit 1 back to the starting position in the receiving container 2 and to uncouple the carrier unit 1. The control unit then controls the removal device 4 to remove the emptied carrier unit 1 with the receiving container 2.

The removal device 4, designed as a flap, opens and the receiving container 2 with the emptied carrier unit 1 slides, as can be seen in FIG. 9, over a type of slide 31, for example a bent sheet metal, from the inclined plane 3. The slide 31 has on its longitudinal sides and on its front side a bent-up portion 33 which serves as a guide and prevents the receiving container 2 from falling from the slide 31 and stops it at the end of the slide 31. From this position, the receiving container 2 together with the carrier unit 1 can be removed by the operator in order to clean both and then refill the carrier unit 1 with tomato slices.

Once the carrier unit 1 with the receiving container 2 has slid from the inclined plane 3 through the flap, another carrier unit la slides into another receiving container 2a. This sliding can be detected by a sensor on the inclined plane, which sends a corresponding signal to the control unit or the transport device 5, which causes the transport device 5 to couple to the further carrier unit la.

For further transport of the separated food products 10, the separation device 100 can optionally have a platform 71 which is adjacent to the upper edge 23 of the receiving container 2 or which is guided in the region of the upper edge 23 of the receiving container 2 and onto which the food products 10 are conveyed. From there they can be transported to the place of further use using, for example, a conveyor belt or a slide.

In the exemplary embodiment in FIG. 8 and FIG. 9, the separation device 100 comprises such a platform 71, which is connected to a motorized lift 7. In the exemplary embodiment, the platform 71 is a plate, for example a horizontal sheet metal, which can be guided by the lift 7 to the upper edge 23 of the receiving container 2.

As can be seen in FIG. 9, the platform 71 is guided to the upper edge 23 or into the region of the upper edge 23 of the receiving container 2 in such a way that tomato slices, which are conveyed by the ejection device 6 from a product carrier 12, slide onto the platform 71. The lift 7 then transports, as shown in FIG. 9, the tomato slice on the platform 71 guided over rails 72 to the location of further use-in the exemplary embodiment, the tomato slices are transported to a further transport device 8.

In the exemplary embodiment, the further transport device 8 comprises one or more containers 81 in which the dishes to be topped with the tomato slices-for example a pizza-are transported on a conveyor belt 82 past the separation device 100 in order to garnish the dishes with the tomato slices. Once the lift has transported the platform 71 into the region of the container 81, the lift 7 tilts the platform 71 and the tomato slice slides onto the pizza in the container 81. The lift then transports the platform 71 back into the region of the upper edge 23 of the container 2 to pick up the next tomato slice.

As an alternative to tilting, the lift 7 can optionally also pull the platform 71 backwards, wherein the tomato slice is initially held in position by a small sheet metal located behind the platform 71, so that the tomato slice then falls straight onto the pizza below.

Furthermore, as an alternative to tilting the platform 71, the platform 71 can optionally also have, for example, a trapdoor in order to release the food product 10 located thereon.

Of course, the movement of the lift can also be controlled by the control unit. It is also possible for several tomato slices to be picked up by the platform 71 before it is transported to the container or the dishes contained therein.

Of course, a separation device 100 according to the invention can also be part of an entire system for preparing assembled foods such as pizzas, sandwiches, tacos or the like. The separation device 100 is therefore designed as a self-contained, independent module that can be reversibly installed and removed from such a system. This allows for easy replacement or removal from the system if the separation device 100 is momentarily not needed.

### LIST OF REFERENCE NUMERALS

1 carrier unit
1a further carrier unit
2 receiving container
2a further receiving container
10 food product
11 tier of the carrier unit
12 product carrier
13 fastening device
14 hook of the transport device
15 stamp of the ejection device
21 bottom of the receiving container
22 wall surface of the receiving container
23 upper edge of the receiving container
24 flange of the receiving container
3 inclined plane
31 slide
32 bracket
33 bent part of the slide
4 removal device
5 transport device
6 ejection device
61 plate of the ejection device
7 lift
71 platform
72 rails
8 further transport device
81 container
82 conveyor belt

1. A separation device (100) for separated dispensing of a sliced food product (10), comprising
a carrier unit (1) with a plurality of tiers (11) for receiving the individual food products (10), wherein the tiers (11) are aligned parallel to each other and each comprise a product carrier (12), on which the individual food products (10) can be respectively placed,
a receiving container (2) for receiving and guiding the carrier unit (1), wherein the carrier unit (1) is received in a starting position, in particular completely, within the receiving container (2),
a transport device (5) that can be coupled to the carrier unit (1) and/or the receiving container (2) and is designed to transport the carrier unit (1) linearly in steps from its starting position out of the receiving container (2), so that one tier (11) of the carrier unit (1) at a time can be transported out of the receiving container (2), and
an ejection device (6) that can be reversibly moved linearly relative to the carrier unit (1) and parallel to the plane of the product carriers (12) from a basic position, in which the ejection device (6) is located outside the carrier unit (1), to an ejection position, in which the ejection device (6) is at least partially inserted between the product carriers (12) of the carrier unit (1) outside and/or inside the receiving container (2), so that food products (10) placed on the product carriers (12) in this way can be conveyed individually out of the carrier unit (1) by the ejection device (6),
wherein the transport device (5) is designed to transport one tier (11) of the carrier unit (1) at a time out of the receiving container (2) when the ejection device (6) assumes the basic position, in particular following an ejection process.

2. The separation device (100) according to claim 1, characterized in that the separation device (100) comprises a control unit connected to the transport device (5) and the ejection device (6), which is designed to
to control the transport device (5) to transport one respective tier (11) of the carrier unit (1) out of the receiving container (2) when the ejection device (6) assumes the basic position and
to control the ejection device (6) for movement from the basic position to the ejection position and from the ejection position to the basic position,
wherein the control unit is designed
after transporting a new tier (11) of the carrier unit (1) from the receiving container (2), to control the ejection device (6) for movement to the ejection position, and then
to control the ejection device (6) to move to the basic position.

3. The separation device (100) according to claim 2, characterized in that the control unit is designed to monitor the transport movement of the transport device (5) and to emit a warning signal after the transport of a predetermined, in particular the last, tier (11) of the carrier unit (1) from the receiving container (2), wherein it is provided in particular that the number of tiers (11) of the carrier unit (1) is stored in the control unit.

4. The separation device (100) according to claim 2, characterized in that the control unit is designed to control the transport device (5) following the transport of the last tier (11) of the carrier unit (1) out of the receiving container (2), to transport the carrier unit (1) back to the starting position in the receiving container (2) and to uncouple the carrier unit (1), wherein in particular it is provided that the number of tiers (11) of the carrier unit (1) is stored in the control unit.

5. The separation device (100) according to claim 1, characterized in that the receiving container (2) is arranged on an inclined plane (3) which is oriented at an angle, in particular of 5 to 45 degrees, to the horizontal, and in that the plane of the individual product carriers (12) of the carrier unit (1) in their state guided in the receiving container (2) is oriented substantially at the same angle to the horizontal.

6. The separation device (100) according to claim 5, characterized in that the ejection device (6) is linearly movable in a plane which is oriented at substantially the same angle to the horizontal as the inclined plane (3).

7. The separation device (100) according to claim 5, characterized in that
the separation device (100) comprises at least one further carrier unit (1a) and at least one further receiving container (2a) for receiving and guiding the further carrier unit (1a), wherein the further receiving container (2a) is arranged on the inclined plane (3),
wherein it is provided in particular that the separation device (100) comprises a removal device (4) which is designed to remove, in particular to discharge, the carrier unit (1) and the receiving container (2) from the inclined plane (3) after the carrier unit (1) has been returned to the starting position,
wherein it is preferably provided that the control unit is designed to control the removal device (4) for removal, in particular for discharge, of the carrier unit (1) and the receiving container (2).

8. The separation device (100) according to claim 7, characterized in that the control unit is designed to control the transport device (5) to couple the further carrier unit (1a) after the carrier unit (1) and the receiving container (2) have been removed from the inclined plane (3).

9. The separation device (100) according to claim 1, characterized in that the receiving container (2) has an upper edge (23) and in that the separation device (100) comprises a platform (71) guided to the upper edge (23) of the receiving container (2), wherein food products (10) placed on the product carriers (12) can be conveyed individually from the carrier unit (1) onto the platform (71) by the ejection device (6)
and in particular wherein it is provided that the platform (71)
is oriented at the same angle to the horizontal as the inclined plane (3) or
is oriented horizontally.

10. The separation device (100) according to claim 1, characterized in that the carrier unit (1), in particular each of the product carriers (12) of the carrier unit (1), has a substantially round cross-section and that the receiving container (2) is designed as a hollow cylinder open at one end.

11. The separation device (100) according to claim 1, characterized in that the receiving container (2) has a bottom (21) and that the carrier unit (1) has a fastening device (13), in particular a hook or bracket, on its side facing away from the bottom (21) of the receiving container (2) for coupling to the transport device (5).

12. The separation device (100) according to claim 1, characterized in that the receiving container (2) has a bottom (21) and that the bottom (21) of the receiving container (2) has a fastening device, in particular a hook or bracket, for coupling to the transport device (5), and that the transport device (5) is designed to transport the carrier unit (1) linearly and step by step out of its starting position from the receiving container (2) in this way by moving the bottom (21) of the receiving container (2).

13. The separation device (100) according to claim 1, characterized in that a tier of the carrier unit (1) is delimited by two respective product carriers (12), wherein it is provided in particular that the distance between two respective product carriers (12) corresponds substantially to the height of the food product (10) to be placed on it.

14. The separation device (100) according to claim 1, characterized in that the separation device (100) comprises at least one further carrier unit (1a) and at least one further receiving container (2a) for receiving and guiding the further carrier unit (1a), and
that the separation device (100) comprises a removal device (4) which is designed
after the carrier unit (1) has been returned to the starting position, to remove the carrier unit (1) and the receiving container (2) from the separation device (100), in particular to discharge them, and
to transport the further receiving container (2a) with the further carrier unit (1a), in particular by means of a piston and/or a chain guide, to the location of the previously removed, in particular discharged, receiving container (2),
wherein it is preferably provided that the control unit is designed to control the removal device (4) for removal, in particular for discharge, of the carrier unit (1) and the receiving container (2) and/or for further transport of the further receiving container (2a) with the further carrier unit (1a).

15. A method for separated dispensing of a sliced food product (10) with a separation device (100) according to claim 1
wherein a carrier unit (1) filled with food products (10) is introduced into its starting position in the receiving container (2),
wherein the transport device is coupled to the carrier unit (1) and/or the receiving container (2),
wherein the carrier unit (1) is transported linearly step by step by the transport device (5) from its starting position out of the receiving container (2), and thus each tier (11) of the carrier unit (1) is transported step by step out of the receiving container (2),
wherein the ejection device (6) is moved linearly relative to the carrier unit (1) and parallel to the plane of the product carriers (12), from its basic position, in which the ejection device (6) is located outside the carrier unit (1), to its ejection position, in which the ejection device (6) is introduced outside and/or inside the receiving container (2) at least partially between the product carriers (12) of the carrier unit (2), and thus the food product (10) placed on the product carrier (12) of the in particular last tier (11) transported out of the receiving container

(2) is transported individually out of the carrier unit (1) by the ejection device (6),
wherein the ejection device (6) is moved from the ejection position to the basic position and
wherein a new tier (11) of the carrier unit (1) is transported out of the receiving container (2) by the transport device (5) following the movement of the ejection device (6) to the basic position.

16. A system for preparing assembled foods, characterized in that the system comprises a separation device (100) according to claim 1.

17. The system according to claim 16, characterized in that the separation device (100) is designed in a modular manner so that it can be pulled out of the system and/or replaced.
